(19) United States
(12) Patent Application Publication
(10) Pub. No.: US 2024/0006654 A1
(43) Pub. Date: Jan. 4, 2024

(54) LITHIUM-ION CELL WITH A HIGH SPECIFIC ENERGY DENSITY

(71) Applicant: VARTA Microbattery GmbH, Ellwangen Jagst (DE)

(72) Inventors: Edward PYTLIK, Ellwangen (DE); David ENSLING, Ellwangen (DE)

(21) Appl. No.: 18/026,398

(22) PCT Filed: Sep. 15, 2021
(86) PCT No.: PCT/EP2021/075314

§ 371 Date: Mar. 15, 2023

(30) Foreign Application Priority Data
Sep. 16, 2020 (EP) 20196526.6

(51) Int. Cl. H01M 10/0525; H01M 10/04; H01M 4/75; H01M 4/38; H01M 4/62; H01M 10/0569; H01M 10/0568

(52) U.S. Cl. CPC H01M 10/0525; H01M 10/0431; H01M 4/75; H01M 4/382; H01M 4/625; H01M 10/0569; H01M 10/0568; H01M 2004/027

(57) ABSTRACT

A secondary lithium ion cell includes an electrode-separator assembly in the form of a winding with two terminal end faces. The electrode separator assembly comprising an anode, a cathode, and a separator. The anode comprises an anode current collector comprising a first longitudinal edge, a second longitudinal edge, a strip-shaped main region, and a free edge strip extending along the first longitudinal edge. The strip shaped main region of the anode current collector is loaded with a layer of negative electrode material and the free edge strip of the anode current collector is not loaded with the negative electrode material. The layer of negative electrode material comprises metallic lithium. The cathode comprises a cathode current collector comprising a first longitudinal edge, a second longitudinal edge, a strip-shaped main region, and a free edge strip extending along the first longitudinal edge.

### CROSS REFERENCE TO RELATED APPLICATIONS

This application is a U.S. National Phase application under 35 U.S.C. § 371 of International Application No. PCT/EP2021/075314, filed on Sep. 15, 2021, and claims benefit to European Patent Application No. EP 20196526.6, filed on Sep. 16, 2020. The International Application was published in German on Mar. 24, 2022 as WO 2022/058342 under PCT Article 21(2).

### FIELD

The present disclosure relates to a secondary lithium-ion cell.

### BACKGROUND

Electrochemical cells can convert stored chemical energy into electrical energy by virtue of a redox-reaction. They generally comprise a positive and a negative electrode separated by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is ensured by an ion-conducting electrolyte.

If the discharge is reversible, i.e. if it is possible to reverse the conversion of chemical energy into electrical energy that took place during the discharge and thus to charge the cell again, this is said to be a secondary cell. The designation of the negative electrode as anode and the designation of the positive electrode as cathode, which is generally used for secondary cells, refers to the discharge function of the electrochemical cell.

For many applications today secondary lithium-ion cells are used because they can provide high currents and are characterized by a comparatively high energy density. They are based on the use of lithium, which can migrate between the electrodes of the cell in the form of ions. The negative electrode and the positive electrode of a lithium-ion cell are generally formed by so-called composite electrodes, which comprise electrochemically active components as well as electrochemically inactive components.

In principle, all materials that can absorb and release lithium ions can be used as electrochemically active components (active materials) for secondary lithium-ion cells. Carbon-based particles, such as graphitic carbon, are often used for the negative electrode. Other, non-graphitic carbon materials that are suitable for the intercalation of lithium can also be used. In addition, metallic and semi-metallic materials that are alloyable with lithium can also be used. For example, the elements tin, aluminum, antimony and silicon can form intermetallic phases with lithium. For example, lithium metal oxides such as lithium cobalt oxide (LiCoO₂) and lithium manganese oxide (LiMn₂O₄), lithium iron phosphate (LiFePO₄) or derivatives thereof can be used as active materials for the positive electrode. The electrochemically active materials are generally contained in particle form in the electrodes.

As electrochemically inactive components, the composite electrodes generally comprise a flat and/or strip-shaped current collector, for example a metallic foil, which serves as a carrier for the respective active material. The current collector for the negative electrode (anode current collector) may be formed of copper or nickel, for example, and the current collector for the positive electrode (cathode current collector) may be formed of aluminum, for example. Furthermore, the electrodes can comprise an electrode binder (e.g., polyvinylidene fluoride (PVDF) or another polymer, for example, carboxymethyl cellulose), conductivity-enhancing additives, and other additives as electrochemically inactive components. The electrode binder ensures the mechanical stability of the electrodes and often the adhesion of the active material to the current collectors.

As electrolytes, lithium-ion cells generally comprise solutions of lithium salts such as lithium hexafluorophosphate (LiPF₆) in organic solvents (for example ethers and esters of carbonic acid).

During the manufacture of a lithium-ion cell, the composite electrodes are combined with one or more separators to form an assembly. In this process, the electrodes and separators are usually joined together under pressure, if necessary also by lamination or by bonding. The basic functionality of the cell can then be established by impregnating the assembly with the electrolyte.

In many embodiments, the assembly is formed as a winding or is made into a winding. Generally, it comprises the sequence positive electrode/separator/negative electrode. Often, assemblies are made as so-called bi-cells with the possible sequences negative electrode/separator/positive electrode/separator/negative electrode or positive electrode/separator/negative electrode/separator/positive electrode.

For applications in the automotive sector, for e-bikes or also for other applications with high energy requirements, such as in tools, lithium-ion cells with the highest possible energy density are needed that are simultaneously able to be loaded with high currents during charging and discharging.

Cells for the applications mentioned are often designed as cylindrical round cells, for example with the form factor 21×70 (diameter*height in mm). Cells of this type comprise an assembly in the form of a winding. Modern lithium-ion cells of this form factor can already achieve an energy density of up to 270 Wh/kg. However, this energy density is only considered an intermediate step. The market is already demanding cells with even higher energy densities.

When developing improved electrochemical cells, however, there are other factors to consider than just energy density. Extremely important parameters are also the internal resistance of the cells, which should be kept as low as possible to reduce power losses during charging and discharging, and the thermal connection of the electrodes, which can be essential for temperature regulation of the cell. These parameters are also very important for cylindrical round cells that contain a composite assembly in the form of a winding. During fast charging of cells, heat accumulation can occur in the cells due to power losses, which can lead to massive thermomechanical stresses and subsequently to deformation and damage of the cell structure. The risk is increased if the electrical connection of the current collectors is made via separate, electrically conductive conductor tabs welded to the current collectors, which protrude axially from wound composite assemblies, as heating can occur locally at these conductor tabs under heavy loads during charging or discharging.

WO 2017/215900 A1 describes cells in which the electrode-separator assembly and its electrodes are ribbon-shaped and are in the form of a winding. The electrodes each have current collectors loaded with electrode material. Oppositely poled electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cell has at least one contact element which rests on one of the longitudinal edges in such a way that a line-shaped contact zone is formed. The contact element is connected to the longitudinal edge along the line-shaped contact zone by welding. This makes it possible to electrically contact the current collector and thus also the associated electrode over his/her entire length. This significantly reduces the internal resistance within the cell described. The occurrence of large currents can subsequently be absorbed much better.

Very high energy densities can be achieved in particular when tin, aluminum, antimony and/or silicon are used as active materials in negative electrodes. Silicon has a maximum capacity of more than 3500 mAh/g. This is around ten times more than the specific capacity of graphite. In practice, however, the use of electrode materials with high proportions of the metallic active materials mentioned is associated with difficulties. Particles made of these materials are subject to comparatively strong volume changes during charging and discharging. This results in mechanical stresses and possibly also mechanical damage. For example, proportions of more than 10% silicon in negative electrodes have so far been difficult to control.

### SUMMARY

In an embodiment, the present disclosure provides a secondary lithium-ion cell. The secondary lithium ion cell includes an electrode-separator assembly in the form of a winding with two terminal end faces. The electrode separator assembly comprising an anode, a cathode, and a separator in a sequence anode/separator/cathode. The anode comprises a ribbon-shaped anode current collector comprising a first longitudinal edge, a second longitudinal edge, a strip-shaped main region, and a free edge strip extending along the first longitudinal edge. The strip shaped main region of the anode current collector is loaded with a layer of negative electrode material and the free edge strip of the anode current collector is not loaded with the negative electrode material. The cathode comprises a ribbon-shaped cathode current collector comprising a first longitudinal edge, a second longitudinal edge, a strip-shaped main region, and a free edge strip extending along the first longitudinal edge. The strip shaped main region of the cathode current collector is loaded with a layer of positive electrode material and the free edge strip of the cathode current collector is not loaded with the positive electrode material. The secondary lithium ion cell further includes a housing that encloses the electrode-separator assembly and a metallic contact element in direct contact with a respective first longitudinal edge. The respective first longitudinal edge being the first longitudinal edge of the anode current collector or the first longitudinal edge of the cathode current collector. The metallic contact element is connected to the respective first longitudinal edge by welding. The anode and the cathode are formed and/or arranged relative to each other within the electrode-separator assembly such that the first longitudinal edge of the anode current collector protrudes from one of the terminal end faces and the first longitudinal edge of the cathode current collector protrudes from the other of the terminal end faces. The layer of negative electrode material comprises metallic lithium.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 provides a top view of a current collector;

FIG. 2 provides a sectional view of the current collector shown in FIG. 1;

FIG. 3 provides a top view of an anode that can be processed into an electrode-separator assembly in the form of a winding;

FIG. 4 provides a sectional view of the anode shown in FIG. 3;

FIG. 5 provides a top view of an electrode-separator assembly fabricated using the anode shown in FIG. 3;

FIG. 6 provides a sectional view of the electrode-separator assembly shown in FIG. 5;

FIG. 7 provides cross-sectional views of various embodiments of a contact element of a cell;

FIG. 8 provides a cross-sectional view of a partial representation of an embodiment of a cell;

FIG. 9 provides a cross-sectional view of a partial representation of a further embodiment of a cell;

FIG. 10 provides a cross-sectional view of a representation of a further embodiment of a cell; and

FIG. 11 provides a cross-sectional view of a representation of a further embodiment of a cell.

### DETAILED DESCRIPTION

The present disclosure provides lithium-ion cells characterized by improved energy density compared to prior art and which at the same time have excellent characteristics with respect to their internal resistance and passive heat dissipation capabilities.

According to a first aspect, the present disclosure provides a secondary lithium-ion cell having the immediately following features a. to j. below:
a. The cell comprises a ribbon-shaped electrode-separator assembly with the sequence anode/separator/cathode.
b. The anode comprises a ribbon-shaped anode current collector having a first longitudinal edge and a second longitudinal edge.
c. The anode current collector has a strip-shaped main region loaded with a layer of negative electrode material and a free edge strip extending along the first longitudinal edge that is not loaded with the electrode material.
d. The cathode comprises a ribbon-shaped cathode current collector having a first longitudinal edge and a second longitudinal edge.
e. The cathode current collector has a strip-shaped main region loaded with a layer of positive electrode material and a free edge strip extending along the first longitudinal edge that is not loaded with the electrode material.
f. The electrode-separator assembly is in the form of a winding with two terminal end faces.
g. The electrode-separator assembly is enclosed in a housing.
h. The anode and the cathode are formed and/or arranged within the electrode-separator assembly relative to each other such that the first longitudinal edge of the anode current collector protrudes from one of the terminal faces and the first longitudinal edge of the cathode current collector protrudes from the other of the terminal faces.
i. The cell has a metallic contact element being in direct contact with one of the first longitudinal edges.
j. The contact element is connected to this longitudinal edge by welding.

The cell according to the first aspect is characterized by the following feature:
k. The layer of negative electrode material comprises metallic lithium.

While high-capacity cathodes can store lithium reversibly in the region from 200-250 mAh/g, the theoretical capacity of metallic lithium is about 3842 mAh/g. This enables the production of cells with very thin anodes. On the cathode side, however, a comparatively high surface charge is required. Overall, however, the energy density can be increased considerably.

In some preferred embodiments, the anode may be present as a thin layer of metallic lithium. This layer can be deposited, for example, by means of a CVD or PVD method (CVD=chemical vapor deposition, PVD=physical vapor deposition) from the gas phase on the anode current collector.

Preferably, however, the cell according to first aspect has at least one of the immediately following two additional features a. and b:
a. The layer of negative electrode material comprises a porous, electrically conductive matrix with an open-pore structure.
b. The metallic lithium is embedded in the pores of the matrix.

Preferably, the immediately preceding additional features a. and b. are realized in combination.

If necessary, the anode can comprise at least one further material in addition to the metallic lithium, for example at least one metal with which the lithium is alloyed. If necessary, the at least one further material is likewise incorporated in the pores of the matrix.

One problem that has so far prevented the marketability of cells with metallic lithium anodes is that such anodes are completely degraded during a complete discharge. The volume of the anodes can therefore approach zero during discharge. As in the case of silicon as the active material, this can result in massive volume changes within the cell, which are repeated in the opposite direction during charging. The problem is particularly critical if the cells have a structure in which several layered anodes and cathodes are stacked in alternating sequence. In this case, the respective volume changes add up.

Another problem that can occur with cells with metallic lithium anodes is that the metallic lithium builds up unevenly on the anode side during charging, and in extreme cases dendrites can even form.

The electrically conductive matrix with the open-pore structure ensures that volume changes occurring on the anode side during charging and discharging processes are minimized. Starting from a charged state in which the lithium is at least predominantly, and if necessary also completely, in the pores of the cell, the lithium is depleted in the anode during discharging. In contrast to cells with a metallic lithium anode known from the prior art, however, the anode loses virtually no volume in this process, since this is largely determined by the matrix. During charging, the lithium can be deposited uniformly in the anode again due to the electrical conductivity of the matrix. Uneven lithium deposition and the associated local volume increases or even dendrite formation can thus be avoided. In addition, in combination with the connection of one of the first longitudinal edges via the contact element, voltage and temperature gradients are minimized.

Of great importance is the open-pore structure of the matrix. As is well known, an open-pored structure is a structure that has a plurality of pores that are interconnected by channels or apertures in the pore walls. As a result, open-pored structures generally have a large internal surface area.

In a preferred further development, the cell according to the first aspect is characterized by at least one of the two immediately following additional features a. and b.:
a. The matrix has a porosity in the region from 40 to 95%.
b. The pores in the matrix are characterized by an average diameter in the region from 2 to 50 μm.

Preferably, the immediately preceding additional features a. and b. are realized in combination.

The determination of porosities (ratio of volume of the pores/total volume of the matrix) and pore size distributions is not a hurdle today. There are numerous measuring instruments that perform corresponding determinations according to standardized methods. The above values refer to determinations according to the ISO 15901-1 and DIN 66133 standards.

In possible developments of the immediately preceding feature a., the matrix preferably has a porosity in the region from 50% to 95%, preferably from 70% to 95%, especially from 80% to 95%.

In possible developments of the immediately preceding feature b., the pores in the matrix preferably have an average diameter in the region from 7.5 to 150 μm, preferably from 9 to 130 μm, especially from 10 to 120 μm.

The pores in the matrix are preferably connected to each other by passages having an average diameter in the range from 0.5 μm and 50 μm, more preferably in the region from 1 to 40 μm, in particular in the region from 1 to 25 μm, most preferably from 1 to 10 μm.

Ideally, the matrix consists of a material that does not change chemically during charging and discharging of the cell.

In a preferred development, the cell has at least one of the four immediately following additional features a. to d:
a. The matrix comprises carbon formed by carbonization of an organic compound.
b. The matrix comprises the carbon in a proportion in the region from 50 to 100% by weight.
c. In addition to the carbon, the matrix contains at least one filler which has a higher or lower electrical conductivity than the carbon.
d. The filler is at least one member selected from the group consisting of carbon black, CNT, graphene and metal particles.

Preferably, the immediately preceding additional features a. and b., preferably the immediately preceding additional features a. to d., are realized in combination.

Suitable variants of carbonizable organic compounds and also of methods for carbonization are described in EP 2 669 260 A1, WO 2017/086609 A1 and U.S. Pat. No. 5,510,212 A, the contents of which are hereby incorporated by reference into the present description.

Very preferably, the porous, electrically conductive matrix with an open-pore structure is manufactured from a porous organic compound, in particular a polymer with a porous structure.

The formation of this porous organic compound, in particular of the polymer with the porous structure, can be carried out according to EP 2 669 260 A1, for example, by polymerizing the monomer phase of a monomer-water emulsion, for example by ring-opening metathesis polymerization (ROMP) of a diene compound accessible for this purpose. During polymerization, water droplets are entrapped. After subsequent removal of the water, voids remain in their place. The resulting polymer matrix with these cavities can be carbonized in a subsequent step, whereby intermediate steps such as oxidative treatment may still be necessary.

Carbonization in this context means a conversion of an organic compound to almost pure carbon. Such a conversion generally takes place at very high temperatures and in the absence of oxygen. For example, a polymer can be heated for carbonization to a temperature in the region from 550° C. to 2500° C., preferably in an oxygen-free atmosphere.

The properties of the matrix, in particular its pore size, can also be specifically adjusted according to EP 2 669 260 A1. For this purpose, different amounts of a surfactant can be added to the monomer-in-water emulsion. Preferably, the volume fraction of the surfactant is varied in the region from 0.1% to 8% (based on the amount of polymerizable monomer in the emulsion).

The filler according to feature c. can be used to selectively increase or decrease the electrical conductivity of the matrix. To introduce the filler, it can be added, for example, to the monomer-in-water emulsion mentioned above.

Preferably, the matrix comprises the at least one filler in a proportion in the region from 0.1 to 30% by weight.

In a preferred further development, the cell has the following additional feature a. immediately below:

The layer of negative electrode material on the anode current collector has a thickness in the region from 5 to 100 μm.

The metallic lithium can be introduced into the pores of the matrix by means of electrochemical deposition, for example. For this purpose, the matrix can be contacted with a lithium salt solution and connected to the negative pole of a DC voltage source. Alternatively, a cathode material containing lithium ions, for example an NMC material, can be used on the cathode side. The electrochemical deposition of the metallic lithium in the pores of the matrix then takes place during the first charging. Another possibility would be to deposit the lithium by CVD or PVD.

### Preferred Cathode Side Structure

Suitable active materials for the positive electrode of a cell are, for example, lithium metal oxide compounds and lithium metal phosphate compounds such as LiCoO₂ and LiFePO₄. In particular, derivatives of LiFePO₄ in which Fe is partially replaced by Co, Ni or Mn are also of interest. Further well suited are in particular lithium nickel manganese cobalt oxide (NMC) with the chemical formula LiNiMn_{xy}CoO_{z2} (where x+y+z is typically 1), Lithium manganese spinel (LMO) with the chemical formula LiMn₂O₄, or lithium nickel cobalt alumina (NCA) with the chemical formula LiNiₓCo_{y}Al_{z}O₂ (where x+y+z is typically 1). Derivatives thereof, for example lithium nickel manganese cobalt alumina (NMCA) with the chemical formula Li_{1.11}(Ni_{0.40}Mn_{0.39}Co_{0.16}Al_{0.05})_{0.89}O₂ or Li₁₊ₓM-O compounds and/or mixtures of the above materials can also be used. The cathodic active materials mentioned are preferably used in particulate form.

In a particularly preferred embodiment, the cathode of the cell has at least one of the immediately following additional features a. to e.:
a. The positive electrode material comprises as active material at least one metal oxide compound capable of reversible lithium insertion and removal, preferably an oxide cobalt and/or manganese compound, preferably NMC, NCA or NMCA.
b. The at least one metal oxide compound capable of reversible lithium incorporation and removal is contained in the electrode material in an amount of from 80 wt % to 99 wt %.
c. The positive electrode material comprises an electrode binder and/or a conductive agent.
d. The electrode binder is present in the positive electrode material in an amount of from 0.5% to 15% by weight, preferably from 0.5% to 5% by weight.
e. The conductive agent is present in the positive electrode material in an amount of from 0.1% to 15% by weight, preferably from 0.5% to 3.5% by weight.

Preferably, the immediately preceding additional features a. to e. are realized in combination.

The active materials of the cathode are preferably embedded in a matrix of the electrode binder, with adjacent particles in the matrix preferably being in direct contact with each other. Conducting agents have the function of elevating the electrical conductivity of the electrodes. Common electrode binders are based, for example, on polyvinylidene fluoride (PVDF), polyacrylate or carboxymethyl cellulose. Common conductive agents are carbon black and metal powder.

In another particularly preferred embodiment, the cathode of the cell has at least one of the immediately following additional features a. to e:
a. The layer of positive electrode material comprises a porous, electrically conductive matrix with an open-pore structure.
b. Sulfur is incorporated into this matrix.

Preferably, the immediately preceding additional features a. and b. are implemented in combination.

Thus, in preferred embodiments, the cathode of the cell is a cathode containing sulfur as active material. Thus, the cell may be a lithium-sulfur cell. For example, the cathode may comprise a mixture of sulfur with an additive to improve electrical conductivity, for example from the group comprising graphite, carbon black, CNT and graphene. Alternatively, however, the cathode may comprise the sulfur in a chemically modified form, such as polysulfide.

### Separator

The electrode-separator assembly preferably comprises at least one ribbon-shaped separator, more preferably two ribbon-shaped separators, each having first and second longitudinal edges and two ends.

Preferably, the separators are formed from electrically insulating plastic films. It is preferred that the separators can be penetrated by a liquid electrolyte. For this purpose, the plastic films used can have pores, for example. The foil can consist of a polyolefin or a polyetherketone, for example. Nonwovens and fabrics made of plastic materials or other electrically insulating sheet structures can also be used as separators. Preferably, separators are used that have a thickness in the region from 5 μm to 50 μm.

As an alternative to a separator-liquid electrolyte combination, however, the cell can also have a solid-state electrolyte, for example.

The solid-state electrolyte is preferably a polymer solid-state electrolyte based on a polymer-conducting salt complex, which is present in a single phase without any liquid component. As a polymer matrix, a polymer solid-state electrolyte can have polyacrylic acid (PAA), polyethylene glycol (PEG) or polymethyl methacrylate (PMMA). Lithium conducting salts such as lithium bis(trifluoromethane) sulfonylimide (LiTFSI), lithium hexafluorophosphate (LiPF₆) and lithium tetrafluoroborate (LiBF₄) may be dissolved in these.

If the cell is a lithium-sulfur cell, the separator can have a protective layer that protects the anode from the electrolyte and any lithium sulfides dissolved in it. This protective layer can be applied to the cathode side of the separator, for example.

### Electrolyte

In most cases, it is preferred that the cell comprises a liquid electrolyte, which consists of a solvent or solvent mixture and a lithium ion-containing conducting salt and with which the separator is impregnated. Suitable conducting salts include LiTFSI or LiPF₆ or LiBF₄. Suitable solvents include organic carbonates, in particular ethylene carbonate (EC), propylene carbonate (PC), 1,2-dimethoxyethane (DME), ethyl methyl carbonate (EMC), dimethyl carbonate (DMC) or diethyl carbonate (DEC) and mixtures thereof.

If the cell is a lithium-sulfur cell, for example, a mixture of dioxolane (DOL) and of DME can be used as solvent. In addition, the electrolyte may contain a passivation additive such as lithium nitrate (LiNO₃).

In a first, particularly preferred variant, the cell has, with regard to the electrolyte, at least one of the four immediately following additional features a. to d:
a. The cell comprises an electrolyte comprising a mixture of tetrahydrofuran (THF) and 2-methyltetrahydrofuran (mTHF).
b. The volume ratio of THF:to mTHF in the mixture is in the region from 2:1 to 1:2, most preferably it is 1:1.
c. The cell comprises an electrolyte comprising lithium hexafluorophosphate (LiPF₆) as a conducting salt.
d. The conducting salt is present in the electrolyte in a proportion of 1.5 to 2.5 M, in particular 2 M.

Preferably, the four immediately preceding features a. to d. are realized in combination with each other.

In a second, particularly preferred variant, the cell has, with respect to the electrolyte, at least one of the six immediately following additional features a. to f:
a. The cell comprises an electrolyte comprising a mixture of ethylene carbonate (EC) and dimethyl carbonate (DMC).
b. The volume ratio of EC:to DMC in the mixture is in the region from 1:7 to 5:7, preferably it is 3:7.
c. The cell comprises an electrolyte comprising LiPF₆ as a conducting salt.
d. The conducting salt is present in the electrolyte at a concentration of 1.0 to 2.0 M, in particular 1.2 to 1.5 M.
e. The electrolyte comprises vinylene carbonate, in particular in a proportion of 1 to 3% by weight.
f. The electrolyte comprises ethylene sulfate (DTD), in particular in a proportion of 0.5 to 2 wt. %.

Preferably, the six immediately preceding features a. to f. are realized in combination with each other.

In a third, particularly preferred variant, the cell has, with respect to the electrolyte, at least one of the six immediately following additional features a. to f:
a. The cell comprises an electrolyte comprising a mixture of ethylene carbonate (EC), dimethyl carbonate (DMC) and methyl acetate (MA).
b. The volume fraction of EC and MA in the mixture are each in the region from 20 vol % to 40 vol % and the volume fraction of DMC in the mixture is in the region from 30 vol % to 50 vol %.
c. The cell comprises an electrolyte comprising LiPF₆ as a conducting salt.
d. The conducting salt is present in the electrolyte at a concentration of 1.0 to 2.0 M, in particular 1.2 to 1.5 M.
e. The electrolyte comprises vinylene carbonate, in particular in a proportion of 1 to 3% by weight.
f. The electrolyte comprises ethylene sulfate (DTD), in particular in a proportion of 0.5 to 2% by weight.

Preferably, the six immediately preceding features a. to f. are realized in combination with each other.

In a fourth, particularly preferred variant, the cell has, with respect to the electrolyte, at least one of the following four immediately following additional features a. to d:
a. The cell comprises an electrolyte comprising a mixture of 1,3-dioxolane (DOL) and dimethoxyethane (DME).
b. The volume ratio of DOL:to DME in the mixture is in the region from 2:1 to 1:2, preferably it is 1:1.
c. The cell comprises an electrolyte comprising lithium bis(trifluoromethane) sulfonyl imide (LiTFSI) as a conducting salt.
d. The conducting salt is present in the electrolyte in a concentration of 0.5 to 2.0 M, in particular 1 M.

Preferably, the four immediately preceding features a. to d. are realized in combination with each other.

In a fifth, particularly preferred variant, the cell has, with respect to the electrolyte, at least one of the immediately following four additional features a. to d:
a. The cell comprises an electrolyte comprising at least one solvent selected from the group consisting of acetonitrile (AN), propylene carbonate (PC), tetrahydrofuran (THF), dimethyl carbonate (DMC), diethyl carbonate (DEC), ethyl methyl carbonate (EMC), ethylene carbonate (EC), vinyl carbonate (VC), and fluoroethylene carbonate (FEC).
b. Dissolved in the electrolyte is at least one compound selected from the group consisting of fluoromethane (FM), difluoromethane (DFM), fluoroethane (FE), 1,1-difluoroethane (1,1-DFE), 1,1,1,2-tetrafluoroethane (1,1,1,2-TFE), and 2-fluoropropane (2-FP).
c. The cell comprises an electrolyte comprising lithium bis(trifluoromethane) sulfonyl imide (LiTFSI) as a conducting salt.
d. The conducting salt is present in the electrolyte at a concentration of 0.5 to 2.0 M, in particular 1.2 M.

Preferably, the four immediately preceding features a. to d. are realized in combination with each other.

In a sixth, particularly preferred variant, the cell has, with respect to the electrolyte, at least one of the three immediately following additional features a. to c:
a. The cell comprises an electrolyte comprising at least one solvent selected from the group consisting of propylene carbonate (PC), dimethoxyethane (DME), acetonitrile (AN), dimethyl sulfoxide (DMSO), tetrahydrofuran (THF), sulfolane (SL), and ethyl acetate (EA).
b. The electrolyte comprises a conducting salt in an amount of 2.5 to 6.0 mol.
c. The conducting salt is LiTFSI.

Preferably, the three immediately preceding features a. to c. are realized in combination with each other.

The ribbon-shaped anode, the ribbon-shaped cathode and the ribbon-shaped separator or separators are preferably wound spirally in the electrode-separator assembly in the form of a winding. To produce the electrode-separator assembly, the ribbon-shaped electrodes are fed together with the ribbon-shaped separator or separators to a winding device, in which they are preferably wound spirally around a winding axis. In some embodiments, the electrodes and the separator are wound for this purpose onto a cylindrical or hollow-cylindrical winding core, which is seated on a winding mandrel and remains in the winding after winding. The winding shell can be formed by a plastic film or an adhesive tape, for example. It is also possible for the winding shell to be formed by one or more separator windings.

It is preferred that the longitudinal edges of the separator or separators form the end faces of the electrode-separator assembly formed as a winding.

It is further preferred that the longitudinal edges of the anode current collector and/or the cathode current collector protruding from the terminal end faces of the winding do not exceed 5000 μm, preferably not exceed 3500 μm.

Preferably, the longitudinal edge of the anode current collector protrudes from the end face of the winding no more than 2500 μm, preferably no more than 1500 μm. Preferably, the longitudinal edge of the cathode current collector protrudes from the end face of the winding no more than 3500 μm, preferably no more than 2500 μm.

Preferably, the anode and cathode are offset from each other within the electrode-separator assembly to ensure that the first longitudinal edge of the anode current collector protrudes from one of the terminal end faces and the first longitudinal edge of the cathode current collector protrudes from the other of the terminal end faces.

The current collectors of the cell have the function of electrically contacting electrochemically active components contained in the respective electrode material over as large an area as possible. Preferably, the current collectors consist of a metal or are metallized at least on the surface. Particularly suitable metals for the anode current collector are, for example, copper or nickel or other electrically conductive materials, in particular copper and nickel alloys or metals coated with nickel. Stainless steel is also generally a possibility. Suitable metals for the cathode current collector include aluminum or other electrically conductive materials, including aluminum alloys. Stainless steel, for example of type 1.4404, is also a possibility here.

Preferably, the anode current collector and/or the cathode current collector is in each case a metal foil with a thickness in the region from 4 μm to 30 μm, in particular a ribbon-shaped metal foil with a thickness in the region from 4 μm to 30 μm.

In addition to foils, however, other ribbon-shaped substrates such as metallic or metallized nonwovens or open-pore metallic foams or expanded metals can be used as current collectors.

The current collectors are preferably loaded on both sides with the respective electrode material.

In particularly preferred embodiments, the cell is characterized by at least one of the immediately following features a. to c.:

a. The strip-shaped main region of the current collector connected to the contact element by welding has a plurality of apertures.

b. The apertures in the main area are round or square holes, punched or drilled holes.

c. The current collector connected to the contact element by welding is perforated in the main area, in particular by round hole or slotted hole perforation.

Preferably, the immediately preceding features a. and b. or a. and c., and preferably the three immediately preceding features a. to c., are realized in combination with each other.

The plurality of apertures results in a reduced volume and also in a reduced weight of the current collector. This makes it possible to introduce more active material into the cell and in this way drastically increase the energy density of the cell. Energy density increases up to the double-digit percentage range can be achieved in this way.

In some preferred embodiments, the apertures are introduced into the strip-shaped main region by laser.

In principle, the geometry of the apertures is not essential. What is important is that as a result of the insertion of the apertures, the mass of the current collector is reduced and there is more space for active material, since the apertures can be filled with the active material.

It can be very advantageous to ensure that the maximum diameter of the apertures is not too large when inserting them. Preferably, the dimensions of the apertures should not be more than twice the thickness of the layer of electrode material on the respective current collector.

In particularly preferred embodiments, the cell is characterized by the immediately following feature a.:
a. The apertures in the current collector, especially in the main region, have diameters in the range from 1 μm to 3000 μm.

Within this preferred region, diameters in the range from 10 μm to 2000 μm, preferably from 10 μm to 1000 μm, especially from 50 μm to 250 μm, are further preferred.

Preferably, the cell has at least one of the immediately following features a. and b:
a. The current collector connected to the contact element by welding has, at least in a partial section of the main area, a lower weight per unit area than the free edge strip of the same current collector.
b. The current collector connected to the contact element by welding has no or fewer apertures per unit area in the free edge strip than in the main area.

It is particularly preferred that the immediately preceding features a. and b. are realized in combination with each other.

The free edge strips of the anode and cathode current collector bound the main area toward the first longitudinal edges. Preferably, both the anode and cathode current collectors comprise free edge strips along their respective longitudinal edges.

The apertures characterize the main area. In other words, the boundary between the main region and the free edge strips corresponds to a transition between regions with and without apertures.

The apertures are preferably distributed substantially evenly over the main area.

In further particularly preferred embodiments, the cell has at least one of the following features immediately below a. to c.:
a. The weight per unit area of the current collector in the main area is reduced by 5% to 80% compared to the weight per unit area of the current collector in the free edge strip.
b. The current collector has a hole area in the main region in the range from 5% to 80%.
c. The current collector has a tensile strength of 20 N/mm² to 250 N/mm² in the main area.

It is particularly preferred that the immediately preceding features a. to c. are realized in combination with each other.

The hole area, often referred to as the free cross-section, can be determined according to ISO 7806-1983. The tensile strength of the current collector in the main area is reduced compared to current collectors without the apertures. Its determination can be done according to DIN EN ISO 527 part 3.

It is preferred that the anode current collector and the cathode current collector are identical or similar in terms of apertures. The respective achievable energy density improvements add up. In preferred embodiments, the cell therefore has at least one of the immediately following features a. to c.:
a. The strip-shaped main region of the anode current collector and the main region of the cathode current collector are both characterized by a plurality of the apertures.
b. The cell comprises the contact element connected to one of the first longitudinal edges by welding as the first contact element, and further comprises a second metallic contact element connected to the other of the first longitudinal edges by welding.

It is particularly preferred that the immediately preceding features a. and b. are realized in combination with each other.

The preferred embodiments of the current collector provided with the apertures described above are independently applicable to the anode current collector and the cathode current collector.

The use of perforated current collectors or those otherwise provided with a plurality of apertures has not yet been seriously considered for lithium-ion cells, since it is very difficult to contact such current collectors electrically. As mentioned at the beginning, the electrical connection of the current collectors is often made via separate conductor tabs. However, forming reliable welded connections between these conductor tabs and perforated current collectors is difficult to realize in industrial mass production processes without an unacceptable failure rate.

This problem can be solved by welding the current collector edges to the contact elements as described. This makes it possible to completely dispense with separate conductor tabs, thus allowing the use of current collectors with a low material content and provided with apertures. In particular, in embodiments in which the free edge strips of the current collectors are not provided with apertures, welding can be performed reliably with exceptionally low reject rates.

It should be emphasized that all of the described embodiments, in which the preferably strip-shaped main region of the current collector connected to the contact element by welding has a plurality of apertures, can be realized completely independently of feature k. of claim 1. The present disclosure thus also provides cells having features a. to j. of claim 1, in which the strip-shaped main region of the current collector connected to the contact element by welding has a plurality of apertures, but the anode does not necessarily have the metallic lithium. Instead, the anode may comprise as active material carbon-based particles such as graphitic carbon or non-graphitic carbon materials capable of intercalating lithium, preferably also in particulate form, optionally in combination with a material selected from the group comprising silicon, aluminum, tin and antimony or a compound or alloy of these materials, for example silicon oxide. Alternatively or additionally, lithium titanate (Li₄Ti₅O₂) or a derivative thereof may also be included in the negative electrode, preferably also in particulate form.

In a particularly preferred embodiment, the housing of the cell has at least one of the immediately following features a. and b:
a. The housing enclosing the electrode-separator assembly comprises a metallic tubular housing part with a terminal circular opening.
b. In the housing, the electrode-separator assembly formed as a winding is axially aligned so that the winding shell abuts the inside of the tubular housing part.

It is particularly preferred that the immediately preceding features a. and b. are realized in combination with each other.

Preferably, the cell has the two immediately following features a. and b:
a. The contact element comprises a circular edge.
b. The contact element closes the terminal circular opening of the tubular housing part.

It is therefore proposed to use a contact element with a circular edge and to close the terminal circular opening of the tubular housing part with the contact element. The contact element thus not only serves to make electrical contact with an electrode, but also functions as a housing part. This has a major advantage, as a separate electrical connection between the contact element and a housing part is no longer required. This creates space within the housing and simplifies cell assembly. In addition, direct connection of a housing part to the current collectors of a cell gives it excellent heat dissipation properties.

In a preferred further development, the cell has at least one of the four immediately following features a. to d:
a. The contact element is or comprises a metal disk, the edge of which corresponds to or forms part of the circular edge of the contact element.
b. The metal disk is arranged in the tubular housing part in such that its edge abuts the inside of the tubular housing part along a circumferential contact zone.
c. The edge of the metal disc is connected to the tubular housing part by a circumferential weld seam.
d. One of the first longitudinal edges is connected to the contact element, in particular to the metal disk, by welding.

Preferably, all four immediately preceding features a. to d. are realized in combination with each other.

To enable the edge of the metal disk to abut the inside of the tubular housing part along the circumferential contact zone, it is preferred that the tubular housing part has a circular cross section at least in the section where the edge of the metal disk abuts. It is expedient that the section is hollow cylindrical for this purpose. The inner diameter of the tubular housing part in this section is correspondingly adapted to the outer diameter of the edge of the contact element, in particular to the outer diameter of the metal disk.

Welding of the edge of the metal disc to the tubular housing part can be carried out in particular by means of a laser. Alternatively, however, it would also be possible to fix the metal disk by soldering or bonding.

A separate sealing element is not required in case of a circumferential weld seam. The metal disk and the tubular housing part are sealingly connected via the weld seam. In addition, the welded joint also ensures an almost resistance-free electrical connection between the metal disc and the tubular housing part.

In a further preferred further development, the cell has at least one of the four immediately following features a. to d:
a. The contact element is or comprises a metal disk, the edge of which corresponds to or forms part of the circular edge of the contact element.
b. The cell comprises an annular seal made of an electrically insulating material, which encloses the circular edge of the contact element.
c. The metal disk is arranged in the tubular housing part such that the annular seal abuts the inside of the tubular housing part along a circumferential contact zone.
d. One of the first longitudinal edges is connected to the contact element, in particular to the metal disk, by welding.

Preferably, all four immediately preceding features a. to d. are realized in combination with each other.

In this embodiment, therefore, it is proposed to use as the contact element one having a circular edge, to fit an annular seal made of an electrically insulating material onto the circular edge of the contact element, and to use the contact element to close the terminal circular opening of the tubular housing part.

The cell can be closed, for example, by a crimping or a crimping process in which the seal is compressed.

To enable the annular seal to abut the inside along the circumferential contact zone, it is also preferred that the tubular housing part has a circular cross section at least in the section where the seal abuts. It is expedient for the section to be hollow cylindrical for this purpose. The inside diameter of the tubular housing part in this section is correspondingly adapted to the outside diameter of the edge of the contact element, in particular to the outside diameter of the metal disc with the seal fitted thereon.

The seal itself can be a conventional plastic seal, which should be chemically resistant to the electrolytes used in each case. Suitable sealing materials are known to the skilled person.

The closure variant with the annular seal made of the electrically insulating material means that the contact element is electrically insulated from the tubular housing part. It forms an electrical pole of the cell. In the case of the closure variant in which the edge of the metal disk is connected to the tubular housing part by a circumferential weld seam, the tubular housing part and the contact element have the same polarity.

The contact element can consist of several individual parts, including the metal disk, but they do not necessarily all have to be made of metal.

In the simplest embodiment, the metal disk is a flat sheet metal part with a circular circumference that extends in only one plane. In many cases, however, more elaborate designs may be preferred. For example, the metal disk may be profiled, having around its center one or more circular depressions and/or elevations, preferably in concentric arrangement, which may result, for example, in an undulating cross-section. It is also possible for its inner surface to have one or more ridges or linear depressions and/or elevations. Furthermore, the disc may have an edge that is bent radially inwards, so that it has a double-layered edge region with, for example, a U-shaped cross-section.

In a further development of the first preferred embodiment, the cell has at least one of the three immediately following features a. to c.:
a. The metal disk has at least one channel-shaped and/or point-shaped depression on one of its sides, which emerges as at least one linear and/or point-shaped elevation on its other side.
b. The side with the at least one elevation is in direct contact with one of the first longitudinal edges.
c. The at least one elevation and the one of the first longitudinal edges are connected by at least one welding spot and/or at least one weld seam.

Particularly preferred are the immediately preceding features a. to c. realized in combination.

Preferably, the longitudinal edge is thus welded directly to the elevation. Furthermore, it is preferred that several beads are introduced as elongated depressions.

In a preferred development of the metal disk of the cell, the cell is accordingly characterized by at least one of the following two features a. and b.:
a. The metal disk has on one of its sides several channel-shaped depressions in a preferably star-shaped arrangement, which emerge on its other side as linear elevations.
b. The metal disk comprises at least one weld seam in each of the channel-shaped depressions, preferably two parallel weld seams, as a result of welding the metal disk to one of the first longitudinal edges.

Preferably, the immediately preceding features a. and b. are realized in combination.

The star-shaped arrangement and, if necessary, the double weld seam ensure a good and, above all, uniform bond between the metal disk and one of the first longitudinal edges.

In a particularly preferred further development, the cell has at least one of the immediately following features a. and b:
a. the contact element comprises a contact sheet metal member in addition to the metal disk.
b. The contact sheet metal member is in direct contact with one of the first longitudinal edges and is joined to this longitudinal edge by welding.

Preferably, the immediately preceding features a. and b. are realized in combination.

In this embodiment, the contact element thus comprises at least two individual parts. The metal disc is used here to close the housing, while the contact sheet metal member contacts the longitudinal edge of the current collector.

The contact sheet metal member may have a circular circumference in some preferred embodiments, but this is by no means mandatory. In some cases, the contact sheet metal member may be, for example, a strip of metal, or may have a plurality of strip-shaped segments, such as in a star-shaped arrangement.

Preferably, the first contact element and/or the second contact element, and possibly also the contact sheet metal member of the respective contact element, are dimensioned such that they cover at least 60%, preferably at least 70%, preferably at least 80%, of the respective terminal end face.

Covering the end face over as large an area as possible is important for the thermal management of the cell. The larger the coverage, the more likely it is to contact the longitudinal edge of the respective current collector over its entire length, if possible.

In some embodiments, it has proven advantageous to subject the longitudinal edges of the current collectors to a pretreatment before the contact elements or contact sheet metal members are placed on top. In particular, at least one depression may be folded into the longitudinal edges to correspond to the beads or the at least one linear and/or point-shaped elevation on one side of the contact element.

The longitudinal edges of the current collectors may also have been subjected to directional or non-directional forming by pretreatment. For example, they can be bent or compressed in a defined direction.

In some embodiments, a contact sheet metal member may be used that includes at least one slot and/or at least one perforation. These may have the function of counteracting deformation of the contact sheet metal member when a welded joint is made to the first longitudinal edge.

Furthermore, the contact sheet metal member may have recesses, such as holes or gaps, which serve the purpose of facilitating the distribution of the electrolyte during metering and of facilitating the escape of gases formed during formation or as a result of misuse or defect from the inside of the winding.

Preferably, the contact sheet metal member and the metal disk lie flat on top of each other, at least in some areas, so that a two-dimensional contact surface is provided.

Preferably, the contact sheet metal member and the metal washer are in direct contact with each other. In this case, they are preferably fixed to each other by welding or soldering.

In particularly preferred embodiments, the contact sheet metal member is designed like the contact plates described in WO 2017/215900 A1.

In a particularly preferred embodiment, the contact element can comprise, in addition to the metal disk and optionally also in addition to the contact sheet metal member, a profiled metal pole cover with a circular circumference, which can be welded onto the metal disk and has approximately or exactly the same diameter as the metal disk, so that the edge of the metal disk and the edge of the pole cover together form the edge of the contact element. In a further embodiment, the edge of the pole cover may be enclosed by a radially inwardly bent edge of the metal disk. In preferred embodiments, there may even be a clamp connection between the two individual parts.

The concept of welding the edges of current collectors with contact elements is already known from WO 2017/215900 A1 or from JP 2004-119330 A. This technology enables particularly high current carrying capacities and low internal resistance. With regard to methods for electrically connecting contact elements, in particular also disc-shaped contact elements, to the edges of current collectors, full reference is therefore made to the contents of WO 2017/215900 A1 and JP 2004-119330 A.

In a particularly preferred embodiment, the cell has at least one of the immediately following additional features a. and b:
a. The tubular housing part is part of a housing cup that comprises a circular bottom.
b. The other of the first longitudinal edges abuts directly against the bottom and is preferably connected to the bottom by welding.

Preferably, the immediately preceding features a. and b. are realized in combination.

This variant is particularly suitable for cells according to the closure variant described above with the annular seal made of the electrically insulating material. If the closure variant is used in which the edge of the metal disc is connected to the tubular housing part by a circumferential weld seam, a pole bushing is generally required.

The use of housing cups has been known for a long time in the construction of cell housings, for example from WO 2017/215900 A1 mentioned at the beginning. However, the direct connection of the longitudinal edges of a current collector to the bottom of a housing cup, as proposed here, is not known.

According to the present disclosure, it is therefore possible and preferred to couple the current collector edges of the positive and negative electrodes protruding from opposite end faces of an electrode-separator assembly formed as a winding directly to a housing part in each case, namely the bottom of the cup and the contact element described above, which functions as a closure element. The use of the available internal volume of the cell housing for active components thus approaches its theoretical optimum.

The coupling of the other of the first longitudinal edges to the bottom or to the contact sheet metal member basically follows the same design principles as in the case of coupling of one of the first longitudinal edges to the contact element. The longitudinal edge abuts the bottom so that a line-shaped contact zone results, which in the case of the spirally wound electrodes has a spiral course. Along this linear and preferably spiral contact zone or transversely thereto, a connection of the longitudinal edge to the bottom that is as uniform as possible can be realized by means of suitable welded joints.

In another particularly preferred embodiment, the cell has at least one of the three immediately following additional features a. to c.:
a. The tubular housing part has another terminal circular opening.
b. The cell comprises a closure element with a circular edge that closes this further terminal opening.
c. The closure element for the further terminal opening is or comprises a metal disc, the edge of which corresponds to or forms part of the circular edge of the metal closure element.

Preferably, the immediately preceding features a. to c. are realized in combination.

In this embodiment, the tubular housing part replaces a housing cup together with a closure element. The housing thus consists of three housing parts, one of which is tubular and the other two (the contact element and the closure element) close the terminals of the tubular part as a lid. In terms of production technology, this offers advantages because, unlike housing cups, no deep-drawing dies are required for the manufacture of tubular housing parts. In addition, direct connection of the other of the first longitudinal edges to the closure element results in basically the same advantages as the connection to the bottom of a housing cup described above.

In this embodiment, the tubular housing part is preferably cylindrical or hollow cylindrical. In the simplest embodiment, the closure element is a metal disk with a circular circumference. Further preferably, the metal disk of the closure element can be formed like the metal disk of the contact element.

In some preferred embodiments, the closure element, in particular the metal disk, may have an edge that is bent radially inward so that it or they have a double-layered edge region with, for example, with a U-shaped cross-section.

In a further embodiment, the closure element, in particular the metal disc, may also have an edge that is bent through 900 so that it has an L-shaped cross-section.

In a further development of these particularly preferred embodiments, the cell has at least one the immediately following features a. to c:
a. The metal disk of the closure element or the metal disk forming the closure element is arranged in the tubular housing part in such a way that its edge abuts the inside of the tubular housing part along a circumferential contact zone.
b. The edge of the metal disc is connected to the tubular housing part by a circumferential weld seam.
c. The tubular housing part comprises a circular edge that is bent radially inward over the edge of the closure element, in particular the edge of the metal disk.

Preferably, the immediately preceding features a. and b., and optionally also the immediately preceding features a. to c., are realized in combination.

According to this further development, it is therefore preferable to fix the closure element in the further terminal opening by welding. A separate sealing element is also not required here with a circumferential weld seam.

This further development is particularly preferred if the cell has been sealed according to the first closure variant described above.

Radial bending of the edge of the closure element is an optional measure that is not required to fix the closure element, but may be expedient regardless.

In a further development, the cell has one of the immediately following features a. or b:
a. The other of the first longitudinal edges abuts directly against the metal disk of the closure element or against the metal disk forming the closure element and is connected to the metal disk preferably by welding.
b. The other of the first longitudinal edges is welded to a contact sheet metal member that abuts directly against the metal disk.

In principle, it is also possible that—as in the case of the contact element—there is only an indirect connection via a contact sheet metal member between the longitudinal edge of the other of the first longitudinal edges and the metal disk or the closure element. In this case, there is preferably a connection by direct welding between the contact sheet metal member and the closure element, in particular the metal disc of the closure element. The contact sheet metal member can be designed like its counterpart in the case of the contact element described above.

The coupling of the other of the first longitudinal edges to the metal disk or to the contact sheet metal member of the closure element also follows the same basic design principles as in the case of the coupling of one of the first longitudinal edges to the contact element. The longitudinal edge abuts the metal disc or the contact sheet metal member, resulting in a line-shaped contact zone which, in the case of the spirally wound electrodes, has a spiral course. Along this linear and preferably spiral contact zone or transversely thereto, a connection of the longitudinal edge to the contact sheet metal member that is as uniform as possible can be realized by means of suitable welded joints.

The choice of material from which the housing cup, the metal disk and/or the contact sheet metal member and the closure element or its or their components are made depends on whether the anode or the cathode current collector is attached to the respective housing part. Preferred materials are basically the same materials from which the current collectors themselves are made. For example, said housing parts may consist of the following materials:

Alloyed or unalloyed aluminum, alloyed or unalloyed titanium, alloyed or unalloyed nickel, alloyed or unalloyed copper, stainless steel (for example type 1.4303 or 1.4404), nickel-plated steel.

Furthermore, the housing and its components may consist of multi-layered materials (Clad Materials), for example comprising a layer of steel and a layer of aluminum or copper. In these cases, the layer of aluminum or the layer of copper forms, for example, the inside of the housing cup or the bottom of the housing cup.

Other suitable materials are known to the skilled person.

In the free edge strips, the metal of the respective current collector is preferably free of the respective electrode material. In some preferred embodiments, the metal of the respective current collector is uncovered there so that it is available for electrical contacting, for example by welding to the contact or closure element as mentioned above.

In some further embodiments, however, the metal of the respective current collector in the free edge strips may also be coated, at least in some areas, with a support material that is more thermally resistant than the current collector coated therewith and that is different from the electrode material disposed on the respective current collector.

“Thermally more resistant” in this context is intended to mean that the support material retains its solid state at a temperature at which the metal of the current collector melts. It therefore either has a higher melting point than the metal or it sublimates or decomposes only at a temperature at which the metal has already melted.

The support material can in principle be a metal or a metal alloy, provided that this or these has a higher melting point than the metal from which the surface coated with the support material consists of. In many embodiments, however, the cell preferably has at least one of the immediately following additional features a. to d.:
a. The support material is a non-metallic material.
b. The support material is an electrically insulating material.
c. The non-metallic material is a ceramic material, a glass-ceramic material or a glass.
d. The ceramic material is aluminum oxide (Al₂O₃), titanium dioxide (TiO₂), titanium nitride (TiN), titanium aluminum nitride (TiAlN), a silicon oxide, especially silicon dioxide (SiO₂), or titanium carbonitride (TiCN).

The support material is preferably formed according to the immediately preceding feature b. and preferably according to the immediately preceding feature d.

The term non-metallic material comprises in particular plastics, glasses and ceramic materials.

The term “electrically insulating material” is to be understood broadly in this context. In principle, it comprises any electrically insulating material, in particular also said plastics.

The term ceramic material is to be understood broadly in this context. In particular, this includes carbides, nitrides, oxides, silicides or mixtures and derivatives of these compounds.

By the term “glass-ceramic material” is meant in particular a material comprising crystalline particles embedded in an amorphous glass phase.

The term “glass” basically means any inorganic glass that meets the thermal stability criteria defined above and that is chemically stable to any electrolyte that may be present in the cell.

Preferably, the anode current collector consists of copper or a copper alloy while at the same time the cathode current collector consists of aluminum or an aluminum alloy and the support material is aluminum oxide or titanium oxide.

It may be further preferred that free edge strips of the anode and/or cathode current collector are coated with a strip of the support material.

The main regions, in particular the strip-shaped main regions of the anode current collector and cathode current collector, preferably extend parallel to the respective edges or longitudinal edges of the current collectors. Preferably, the strip-shaped main regions extend over at least 90%, preferably over at least 95%, of the areas of the anode current collector and the cathode current collector.

In some preferred embodiments, the support material is applied immediately adjacent to the preferably strip-shaped main regions in the form of a strip or line, but does not completely cover the free regions in the process, so that immediately along the longitudinal edge the metal of the respective current collector is exposed.

The cell may be a button cell. Button cells are cylindrical in shape and have a height that is less than their diameter. Preferably, the height is in the region from 4 mm to 15 mm. It is further preferred that the button cell has a diameter in the region from 5 mm to 25 mm. Button cells are suitable, for example, for supplying electrical energy to small electronic devices such as watches, hearing aids and wireless headphones.

The nominal capacity of a button cell in the form of a lithium-ion cell is generally up to 1500 mAh. Preferably, the nominal capacity is in the region from 100 mAh to 1000 mAh, preferably in the region from 100 to 800 mAh.

Preferably, however, the cell is a cylindrical round cell. Cylindrical round cells have a height that is greater than their diameter. They are particularly suitable for the applications mentioned at the beginning with high energy requirements, for example in the automotive sector or for e-bikes or for power tools.

Preferably, the height of cells designed as round cells is in the region from 15 mm to 150 mm. The diameter of cylindrical round cells is preferably in the region from 10 mm to 60 mm. Within these regions, form factors of, for example, 18×65 (diameter*height in mm) or 21×70 (diameter*height in mm) are particularly preferred. Cylindrical round cells with these form factors are particularly suitable for supplying power to electric drives in motor vehicles.

The nominal capacity of the cylindrical round cell, designed as a lithium-ion cell, is preferably up to 90000 mAh. With the form factor of 21×70, the cell in one embodiment as a lithium-ion cell preferably has a nominal capacity in the region from 1500 mAh to 7000 mAh, preferably in the region from 3000 to 5500 mAh. With the form factor of 18×65, the cell in one embodiment as a lithium-ion cell preferably has a nominal capacity in the region from 1000 mAh to 5000 mAh, preferably in the region from 2000 to 4000 mAh.

In the European Union, manufacturers are strictly regulated in providing information on the nominal capacities of secondary batteries. For example, information on the nominal capacity of secondary nickel-cadmium batteries must be based on measurements according to the IEC/EN 61951-1 and IEC/EN 60622 standards, information on the nominal capacity of secondary nickel-metal hydride batteries must be based on measurements according to the IEC/EN 61951-2 standard, information on the nominal capacity of secondary lithium batteries must be based on measurements according to the IEC/EN 61960 standard, and information on the nominal capacity of secondary lead-acid batteries must be based on measurements according to the IEC/EN 61056-1 standard. Any information on nominal capacities in the present application is preferably also based on these standards.

The anode current collector, the cathode current collector and the separator are preferably ribbon-shaped in embodiments in which the cell is a cylindrical round cell and preferably have the following dimensions:
A length in the region from 0.5 m to 25 m; and
A width in the region from 30 mm to 145 mm

In these cases, the free edge strip extending along the first longitudinal edge, which is not loaded with the electrode material, preferably has a width of no more than 5000 μm.

In the case of a cylindrical round cell with the form factor 18×65, the current collectors preferably have a width of 56 mm to 62 mm, preferably 60 mm, and a length of not more than 2 m, preferably not more than 1.5 m.

In the case of a cylindrical round cell with the form factor 21×70, the current collectors preferably have a width of 56 mm to 68 mm, preferably 65 mm, and a length of not more than 3 m, preferably not more than 2.5 m.

In a particularly preferred embodiment, the cell is characterized by the following additional feature:
a. The contact element comprises a safety valve via which pressure can escape from the housing if a further pressure threshold is exceeded.

This safety valve can be, for example, a bursting diaphragm, a bursting cross or a similar predetermined cracking point, which can rupture at a defined overpressure in the cell in order to prevent an explosion of the cell. Preferably, the metal disk of the contact element can have the safety valve, in particular in the form of a predetermined cracking point.

The use of an anode comprising metallic lithium is not limited to cylindrical cells. Rather, energy storage elements comprising a stack enclosed by a prismatic housing formed from two or more identical electrode-separator assemblies may also comprise such anodes.

The disclosure therefore also provides an energy storage element having the immediately following features a. to k.:
a. The energy storage element comprises at least two electrode-separator assemblies with the sequence anode/separator/cathode.
b. The anodes of the assemblies are preferably rectangular in shape and each comprise an anode current collector with an anode current collector edge.
c. The anode current collectors each have a main region loaded with a layer of negative electrode material and a free edge strip extending along the respective anode current collector edge that is not loaded with the electrode material.
d. The cathodes of the assemblies are preferably rectangular in shape and each comprise a cathode current collector with a cathode current collector edge.
e. The cathode current collectors each have a main region loaded with a layer of positive electrode material and a free edge strip extending along the respective cathode current collector edge that is not loaded with the electrode material.
f. The at least two electrode-separator assemblies are stacked on top of each other, wherein the stack consisting of the assemblies comprises two terminal sides.
g. The stack of the electrode-separator assemblies is enclosed in a prismatic housing.
h. The anodes and the cathodes are formed and/or arranged relative to each other such that the anode current collector edges protrude from one of the terminal sides and the cathode current collector edges protrude from the other of the terminal sides.
i. The energy storage element comprises a metallic contact element that is in direct contact with said anode current collector edges or said cathode current collector edges.
j. The contact element is joined to the edges with which it is in direct contact by welding.
k. The layer of negative electrode material comprises metallic lithium.

With regard to the layer of negative electrode material, the layer of positive electrode material, the separator and the electrolyte, the same preferred developments apply as in the case of the lithium-ion cell.

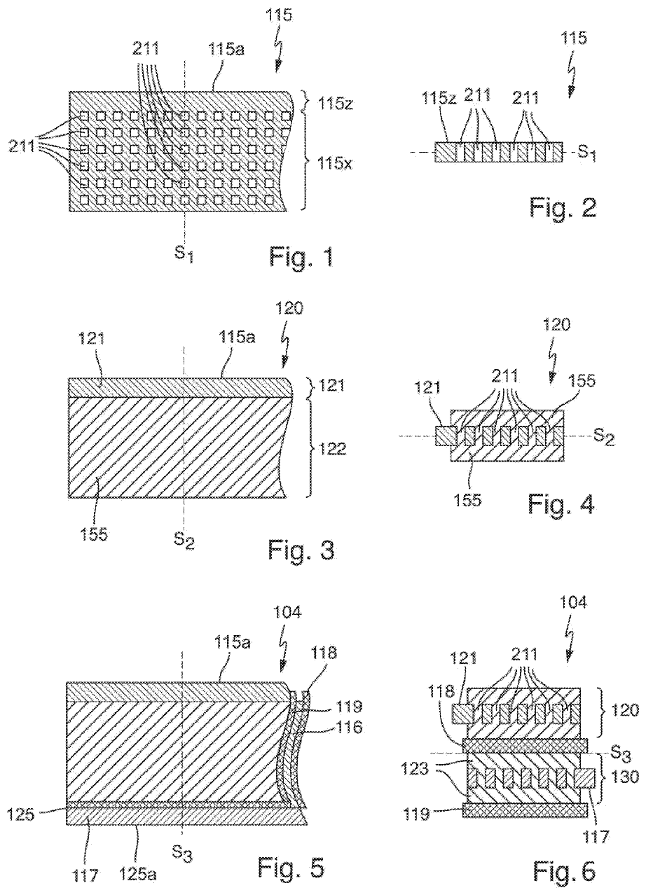

FIG. 1 and FIG. 2 illustrate the design of a current collector 115 that can be used in a cell. FIG. 2 is a sectional view along S₁. The current collector 115 comprises a plurality of apertures 211, which are rectangular holes. The region 115x is characterized by the apertures 211, whereas no apertures are found in the region 115z along the longitudinal edge 115a. Therefore, the current collector 115 has a significantly lower weight per unit area in the region 115x than in the region 115z.

FIG. 3 and FIG. 4 illustrate an anode 120 fabricated by applying a negative electrode material 155 to both sides of the current collector 115 shown in FIG. 1 and FIG. 2. FIG. 4 is a sectional view along S₂. The current collector 115 now has a strip-shaped main region 122 loaded with a layer of the negative electrode material 123, and a free edge strip 121 extending along the longitudinal edge 115a that is not loaded with the electrode material 155. In addition, the electrode material 155 also fills the apertures 211.

FIG. 5 and FIG. 6 illustrate an electrode-separator assembly 104 fabricated using the anode 120 shown in FIG. 3 and FIG. 4. In addition, it comprises the cathode 130 and the separators 118 and 119. FIG. 6 is a sectional view along S₃. The cathode 130 builds on the same current collector design as the anode 120. Preferably, the current collectors 115 and 125 of the anode 120 and cathode 130 differ only in their respective material choices. For example, the current collector 125 of cathode 130 comprises a strip-shaped main region 116 loaded with a layer of positive electrode material 123, and a free edge strip 117 extending along longitudinal edge 125a that is not loaded with electrode material 123. By spirally winding, the electrode-separator assembly 104 can be transformed into a winding such as may be included in a cell.

In some preferred embodiments, the free edge strips 117 and 121 are coated on both sides and at least in some areas with an electrically insulating support material, for example a ceramic material such as silicon oxide or aluminum oxide.

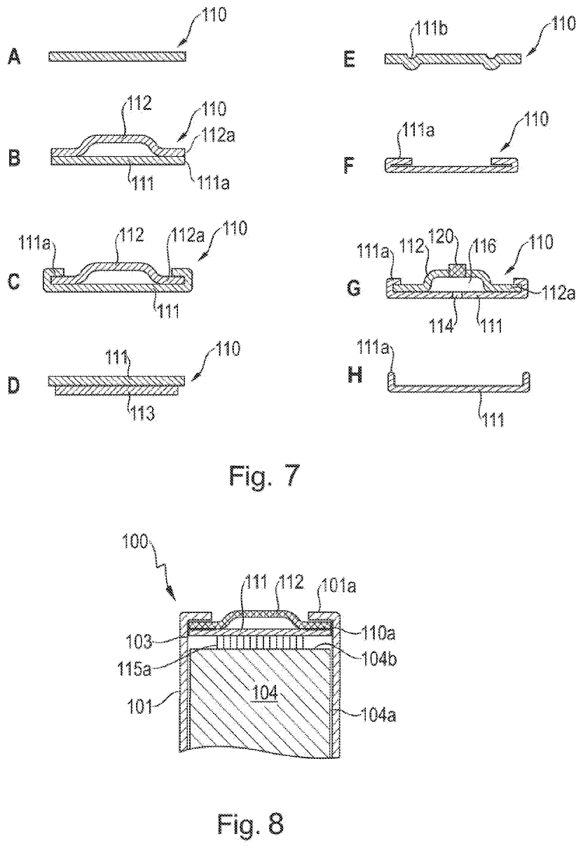

FIG. 7 provides cross-sectional views of various embodiments A to H of contact elements 110 suitable for sealing cells 100. In detail:

A Here is shown the simplest embodiment of a contact element 110, namely a flat metal disk with a circular circumference which extends in only one plane. The metal disk may consist of aluminum, for example.

B The contact element 110 shown here comprises the metal disk 111 and the metal pole cover 112. The metal disk 111 and the pole cover 112 each have a circular circumference and an identical diameter. While the metal disk 111 extends in only one plane, the pole cover 112 has a central bulge. The two parts 111 and 112 of the contact element 110 are preferably joined together by welding (not shown).

C The contact element 110 shown here comprises the metal disk 111 and the metal pole cover 112. The pole cover 112 is designed analogously to the pole cover in B. However, the edge 111a of the metal disk 111 is bent radially inward here, so that the metal disk 111 has a U-shaped cross section in the edge region. The bent edge 111a encloses the edge 112a of the pole cover 112 and thus fixes the pole cover 112 to the metal disk 111. Notwithstanding this, it is preferred if the metal disk 111 and the pole cover 112 are additionally welded together.

D The contact element 110 shown here comprises the metal disk 111 and the metal contact sheet metal member 113. The contact sheet metal member 113 abuts flatly against the metal disk 111 and is preferably welded thereto. The metal disk 111 may consist of stainless steel, for example, and the contact sheet metal member 113 may consist of an aluminum alloy, for example.

E The contact element 110 shown here comprises only a metal disk. In contrast to the metal disk shown in A, this has a circular depression 111b on its upper side and a corresponding elevation on its lower side, i.e. it is profiled.

F The contact element 110 shown here comprises only a metal disk. In contrast to the metal disk shown in A, this has a radially inwardly folded edge 111a and consequently a double-layered edge region.

G The contact element 110 shown here comprises the metal disk 111 and the metal pole cover 112, which has a central bulge. The edge 111a of the metal disk 111 is bent radially inward so that the metal disk 111 has a U-shaped cross-section in the edge region. The bent-over edge 111a encloses the edge 112a of the pole cap 112 and thus fixes the pole cap 112 to the metal disk 111. Preferably, the edges 111a and 112a of the metal disk 111 and of the pole cap 112 are additionally connected to one another by welding (not shown). In the center of the metal disk 111 is found the hole 114, through which a cavity 116 is accessible, which is enclosed by the metal disk 111 and the pole cover 112. An overpressure protection device 120 is integrated into the pole cover 112, which can be triggered in the event of an overpressure in the cavity 116. In the simplest case, the overpressure protection 120 may be a predetermined cracking point.

H The contact element shown here comprises only one metal disk 111, which has an edge 111a with an L-shaped cross section that is bent over by 90°.

Closure elements, which can be used within the scope of the housing variant with two lids described above, can preferably also be designed according to embodiments A to H.

The cell 100 shown in FIG. 8 comprises the contact element 110 shown in FIG. 7B, the edge 110a of which is formed by the edges 111a and 112a of the metal disk 111 and the metal pole cover 112. Together with the hollow-cylindrical metallic housing part 101, the contact element 110 forms the housing of the cell 100 and closes a terminal opening of the housing part 101. The edge 110a of the contact element abuts the inner side 101b of the tubular housing part 101 along a circumferential contact zone and is connected to the tubular housing part 101 by a circumferential weld seam. The edge 101a of the housing part 101 is bent radially inwardly over the edge 110a of the contact element 110.

In the housing, the spirally wound electrode-separator assembly 104 is axially aligned so that its winding shell 104a abuts the inside of the tubular housing part 101. The longitudinal edge 115a of the anode current collector protrudes from the upper end face 104b of the electrode-separator assembly formed as a winding. This is welded directly to the underside of the metal disk 111.

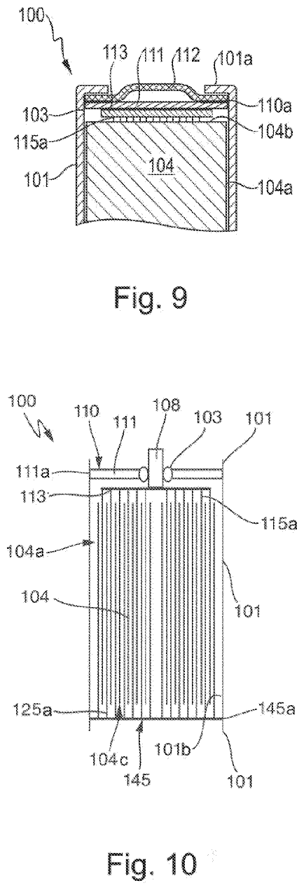

The cell 100 shown in FIG. 9 comprises the contact element 110 shown in FIG. 1B, the edge 110a of which is formed by the edges 111a and 112a of the metal disk 111 and the pole cover 112. Together with the hollow-cylindrical metallic housing part 101, the contact element 110 forms the housing of the cell 100 and closes a terminal opening of the housing part 101. The edge 110a of the contact element abuts the inside 101b of the tubular housing part 101 along a circumferential contact zone and is connected to the tubular housing part 101 by a circumferential weld seam. The edge 101a of the housing part 101 is bent radially inwardly over the edge 110a of the contact element 110.

The contact element 110 further comprises a contact sheet metal member 113 having two sides, one of which faces toward the metal disk 111, even abuts flatly thereagainst, and is joined to the metal disk 111 by welding.

In the housing, the spirally wound electrode-separator assembly 104 is axially aligned so that its winding shell 104a abuts the inside of the tubular metal housing part 101. The longitudinal edge 115a of the anode current collector protrudes from the upper end face 104b of the electrode-separator assembly formed as a winding. This abuts directly against the underside of the contact sheet metal member 113 and is welded to the underside of the contact sheet metal member 113.

The cell 100 shown in FIG. 10 is an example of a third preferred variant described above. It comprises the electrode-separator assembly 104, which is axially inserted into the hollow-cylindrical housing part 101 so that its winding shell 104a abuts the inner surface 101b of the tubular housing part 101. The electrode-separator assembly 104 comprises a spirally wound ribbon-shaped anode and a spirally wound ribbon-shaped cathode. The anode comprises a ribbon-shaped anode current collector and the cathode comprises a ribbon-shaped cathode current collector. The anode current collector is loaded with a layer of negative electrode material. The cathode current collector is loaded with a layer of positive electrode material.

The longitudinal edge 115a of the anode current collector protrudes from the upper end face 104b of the electrode-separator assembly 104 which is formed as a winding. The longitudinal edge 125a of the cathode current collector protrudes from the lower end face 104c of the electrode-separator assembly 104 which is in the form of a winding.

The cell 100 comprises the tubular and hollow cylindrical metal housing part 101, which has two terminal openings. The top opening is closed by the metal disk 111, which is arranged in the tubular housing part 101 in such a way that its edge 111a abuts the inside 101b of the tubular housing part 101 along a circumferential contact zone. The edge 111a of the metal disk 111 is connected to the tubular housing part 101 by a circumferential weld seam.

The metal disk 111 is part of a contact element 110 which, in addition to the metal disk 111, comprises the contact sheet metal member 113 and the pole pin 108. The metallic contact sheet metal member 113 comprises two sides, one of which, in the figure the upper side, points in the direction of the metal disk 111. The longitudinal edge 115a abuts directly against the other side of the contact sheet metal member 113, in this case the lower side. The longitudinal edge 115a is connected to the contact sheet metal member 113 by welding. The pole pin 108 is welded to the contact sheet metal member 113 and extends out of the housing of the cell 100 through a central aperture in the metal disk 111.

The contact element 110 further comprises the insulating means 103, which electrically insulates the pole pin 108 and thus also the contact sheet metal member 113 welded to the pole pin from the metal disk 111.

The bottom opening of the housing part 101 is closed by the closure element 145. The closure element 145 is a metal disk whose edge 145a abuts the inside 101b of the tubular housing part 101 along a circumferential contact zone. The edge 145a of the closure element 145 is connected to the tubular housing part 101 by a circumferential weld seam.

The longitudinal edge 125a of the cathode current collector abuts directly against the inner (upper) side of the contact sheet metal member 113. The longitudinal edge 125a is connected to the closure element 145 by welding. The welding can be effected, for example, by welding through the metal disc of the closure element 145 by means of a laser.

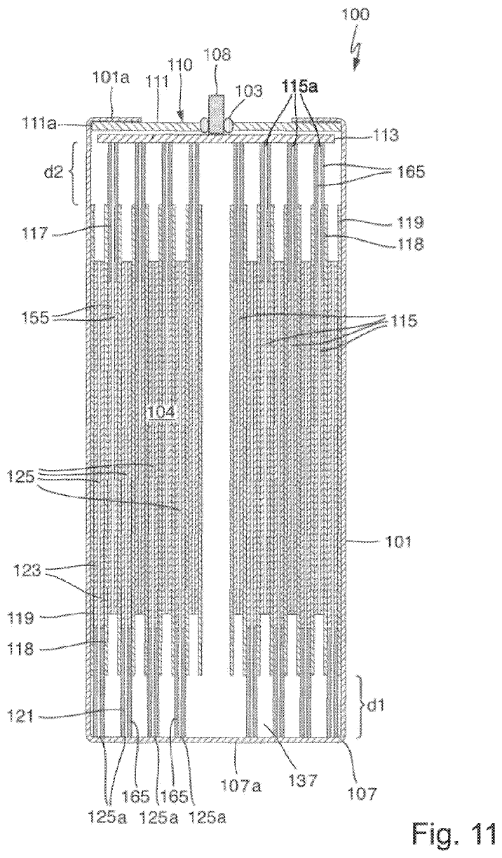

The cell 100 shown in FIG. 11 comprises a hollow cylindrical housing part 101 that is part of the housing cup 107, which comprises the circular bottom 107a and a circular opening (defined by the edge 101a). The housing cup 107 is a deep drawn part. The housing cup 107, together with the contact element 110 comprising the flat metal disk 111 having the circular edge 111a, encloses an interior space 137 in which the electrode-separator assembly 104 formed as a winding is axially aligned. The metal disk 111 is arranged in the tubular housing part 101 such that its edge 111a abuts the inner surface 101b of the tubular housing part 101 along a circumferential contact zone. Its edge 111a corresponds to the edge of the contact element and is connected to the tubular-shaped housing part 101 by a circumferential weld seam. The edge 101a of the tubular housing part 101 is bent radially (here by about 90°) inwards over the edge 110a of the contact element 110.

The electrode-separator assembly 104 is in the form of a cylindrical winding with two terminal end faces, between which the circumferential winding shell extends, abutting the inside of the hollow-cylindrical housing part 101. It is formed of a positive electrode and a negative electrode and separators 118 and 119, each of which is ribbon-shaped and spirally wound. The two end faces of the electrode-separator assembly 104 are formed by the longitudinal edges of the separators 118 and 119. The current collectors 115 and 125 protrude from these end faces. The corresponding protrusions are labeled d1 and d2.

The anode current collector 115 protrudes from the upper end face of the electrode-separator assembly 104, and the cathode current collector 125 protrudes from the lower end face. The anode current collector 115 is loaded in a strip-shaped main region with a layer of a negative electrode material 155. The cathode current collector 125 is loaded in a strip-shaped main region with a layer of a positive electrode material 123. The anode current collector 115 has an edge strip 117 extending along its longitudinal edge 115a, which is not loaded with the electrode material 155. Instead, a coating 165 of a ceramic support material is applied here to stabilize the current collector in the range from this region. The cathode current collector 125 has an edge strip 121 extending along its longitudinal edge 125a, which is not loaded with the electrode material 123. Instead, the coating 165 of the ceramic support material is applied here as well.

In addition to the metal disk 111, the contact element 110 further comprises the contact sheet metal member 113 and the pole pin 108. The metal contact sheet metal member 113 comprises two sides, one of which, in the figure the upper side, faces in the direction of the metal disk 111. On the other side of the contact sheet metal 113, in this case the side at the bottom, the longitudinal edge 115a is in direct contact with the contact sheet metal 113 and thus with the contact element 110 over its entire length and is connected thereto by welding over at least several sections, preferably over its entire length. Alternatively, the multi-pin connection described above may be present here. The contact element 110 thus serves simultaneously for electrical contacting of the anode and as a housing part.

The pole pin 108 is welded to the contact sheet metal member 113 and extends out of the housing of the cell 100 through a central aperture in the metal disk 111. The contact element 110 further comprises the insulating means 103, which electrically insulates the pole pin 108 and thus also the contact sheet metal member 113 welded to the pole pin from the metal disk 111. Only the metal disk 111 is in direct contact with, and thus also in electrical contact with, the housing cup 107. The pole pin 108 and the contact sheet metal member 113 are insulated from the housing cup.

The edge 125a of the cathode current collector 125 is in direct contact with the bottom 107a over its entire length and is connected to the latter by welding (in particular with the aid of a laser) over at least several sections, preferably over its entire length. Alternatively, the multi-pin connection described above may also be present here. The bottom 107a thus serves not only as part of the housing but also for electrical contacting of the cathode.

For example, the electrode-separator assembly 104 may comprise a positive electrode of 95 wt % NMCA, 2 wt % of an electrode binder, and 3 wt % carbon black as a conductive agent. The anode 101 may comprise a porous, electrically conductive matrix 101b with an open-pore structure in whose pores metallic lithium is incorporated. The electrolyte can be a 2 M solution of LiPF₆ in THF/mTHF (1:1) or a 1.5 M solution of LiPF₆ in FEC/EMC (3:7) with 2 wt % VC.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A secondary lithium-ion cell comprising:
an electrode-separator assembly in the form of a winding with two terminal end faces, the electrode separator assembly comprising an anode, a cathode, and a separator in a sequence anode/separator/cathode, wherein the anode comprises a ribbon-shaped anode current collector comprising a first longitudinal edge, a second longitudinal edge, a strip-shaped main region, and a free edge strip extending along the first longitudinal edge, wherein the strip shaped main region of the anode current collector is loaded with a layer of negative electrode material and the free edge strip of the anode current collector is not loaded with the negative electrode material, wherein the cathode comprises a ribbon-shaped cathode current collector comprising a first longitudinal edge, a second longitudinal edge, a strip-shaped main region, and a free edge strip extending along the first longitudinal edge, wherein the strip shaped main region of the cathode current collector is loaded with a layer of positive electrode material and the free edge strip of the cathode current collector is not loaded with the positive electrode material;
a housing that encloses the electrode-separator assembly; and
a metallic contact element in direct contact with a respective first longitudinal edge, the respective first longitudinal edge being the first longitudinal edge of the anode current collector or the first longitudinal edge of the cathode current collector, the metallic contact element being connected to the respective first longitudinal edge by welding,
wherein the anode and the cathode are formed and/or arranged relative to each other within the electrode-separator assembly such that the first longitudinal edge of the anode current collector protrudes from one of the terminal end faces and the first longitudinal edge of the cathode current collector protrudes from the other of the terminal end faces, and
wherein the layer of negative electrode material comprises metallic lithium.

2: The cell according to claim 1, wherein the layer of negative electrode material comprises a porous, electrically conductive matrix with an open-pore structure, and
wherein the metallic lithium is embedded in pores of the matrix.

3: The cell according to claim 2, wherein the matrix has a porosity in a range of from 40 to 95%, and
wherein the pores of the matrix have an average diameter in a range of from 2 to 50 μm.

4: The cell according to claim 2, wherein one or more of:
the matrix comprises carbon formed by carbonization of an organic compound,
the matrix comprises the carbon in a proportion in a range of from 50 to 100% by weight,
the matrix comprises a filler having a higher or lower electrical conductivity than the carbon, and/or
the filler comprises one or more of carbon black, CNT, graphene, and/or metal particles.

5: The cell according to claim 1, wherein the layer of negative electrode material on the anode current collector has a thickness in a range of from 5 to 100 μm.

6: The cell according to claim 1, wherein one or more of:
the positive electrode material comprises, as active material, at least one metal oxide compound capable of reversible lithium incorporation and removal,
the at least one metal oxide compound capable of reversible lithium incorporation and removal is contained in the positive electrode material in an amount of from 80 wt % to 99 wt %,
the positive electrode material comprises an electrode binder and/or a conductive agent,
the electrode binder is contained in the positive electrode material in an amount of 0.5 wt. % to 15 wt. %, and/or
the conductive agent is present in the positive electrode material in an amount of 0.1 wt % to 15 wt %.

7: The cell according to claim 1, wherein the layer of positive electrode material comprises a porous, electrically conductive matrix with an open-pore structure, and
wherein sulfur is incorporated into the matrix.

8: The cell according to claim 1, wherein one or more of:
the cell comprises an electrolyte comprising a mixture of tetrahydrofuran (THF) and 2-methyltetrahydrofuran (mTHF),
the volume ratio of THF:to mTHF in the mixture is in a range or from 2:1 to 1:2,
the cell comprises an electrolyte comprising lithium hexafluorophosphate (LiPF6) as a conducting salt, and/or
the conducting salt is present in the electrolyte in a proportion of 1.5 to 2.5 M.

9: The cell according to claim 1, wherein one or more of:
the cell comprises an electrolyte comprising a mixture of ethylene carbonate (EC) and dimethyl carbonate (DMC),
the volume ratio of EC:to DMC in the mixture is in a range of from 1:7 to 5:7,
the cell comprises an electrolyte comprising LiPF₆ as a conducting salt,
the conducting salt is present in the electrolyte at a concentration of 1.0 to 2.0 M,
the electrolyte comprises vinylene carbonate, and/or
the electrolyte comprises ethylene sulfate (DTD).

10: The cell according to claim 1, wherein one or more of:
the cell comprises an electrolyte comprising a mixture of ethylene carbonate (EC), dimethyl carbonate (DMC) and methyl acetate (MA),
the volume fraction of EC and MA in the mixture are each in a range of from 20 vol % to 40 vol % and the volume fraction of DMC in the mixture is in a range of from 30 vol % to 50 vol %,
the cell comprises an electrolyte comprising LiPF₆ as a conducting salt,
the conducting salt is present in the electrolyte at a concentration of 1.0 to 2.0 M,
the electrolyte comprises vinylene carbonate, and/or
the electrolyte comprises ethylene sulfate (DTD).

11: The cell according to claim 1, wherein at least one of:
the cell comprises an electrolyte comprising a mixture of 1,3-dioxolane (DOL) and dimethoxyethane (DME),
the volume ratio of DOL:to DME in the mixture is in the region from 2:1 to 1:2,
the cell comprises an electrolyte comprising lithium bis(trifluoromethane) sulfonyl imide (LiTFSI) as a conducting salt, and/or
the conducting salt is present in the electrolyte in a concentration of 0.5 to 2.0 M.

12: The cell according to claim 1, wherein one or more of:
the cell comprises an electrolyte comprising one or more of acetonitrile (AN), propylene carbonate (PC), tetrahydrofuran (THF), dimethyl carbonate (DMC), diethyl carbonate (DEC), ethyl methyl carbonate (EMC), ethylene carbonate (EC), vinyl carbonate (VC), and/or fluoroethylene carbonate (FEC),
at least one of fluoromethane (FM), difluoromethane (DFM), fluoroethane (FE), 1,1-difluoroethane (1,1-DFE), 1,1,1,2-tetrafluoroethane (1,1,1,2-TFE), and/or 2-fluoropropane (2-FP) is dissolved in the electrolyte,
the cell comprises an electrolyte comprising lithium bis(trifluoromethane) sulfonyl imide (LiTFSI) as a conducting salt, and/or
the conducting salt is present in the electrolyte at a concentration of 0.5 to 2.0 M.

13: The cell according to claim 1, wherein at least one of:
the cell comprises an electrolyte comprising one or more of propylene carbonate (PC), dimethoxyethane (DME), acetonitrile (AN), dimethyl sulfoxide (DMSO), tetrahydrofuran (THF), sulfolane (SL), and/or ethyl acetate (EA),
the electrolyte comprises a conducting salt in an amount of 2.5 to 6.0 mol, and/or
the conducting salt is LiTFSI.
